(19) United States
(12) Patent Application Publication
(10) Pub. No.: US 2006/0268858 A1
(43) Pub. Date: Nov. 30, 2006

(54) Communication system supporting two-way on-hold functionality

(76) Inventors: Anthony Richard Hagale, Austin, TX (US); Ryan Rozich, Austin, TX (US); Rhys Ulerich, Austin, TX (US); Paul Stuart Williamson, Round Rock, TX (US); Scott Lee Winters, Austin, TX (US)

Correspondence Address: IBM CORP. (AVE);C/O LAW OFFICE OF ANTHONY ENGLAND, PO BOX 5307, AUSTIN, TX, 78763-5307, US

(21) Appl. No.: 11/141,581

(22) Filed: May 31, 2005

(51) Int. Cl. H04L 12/56

(52) U.S. Cl. 370/389; 370/400

(57) ABSTRACT

A communication system and method include a first user agent initiating a telephone call to a second user agent. An intermediary agent establishes a first connection to the first user agent and a second connection to the second user agent. If the intermediary determines that the second user agent has placed the first user agent on hold, the intermediary terminates the first connection while maintaining the second connection on behalf of the first user agent. When the second user agent becomes available, it informs the intermediary. The intermediary then determines the availability of the first user agent. If the first user agent is available, it is connected to the second user agent. The agents preferably communicate over an IP network using session initiation protocol (SIP) compliant messages. The agents and the intermediary are configured to differentiate between a SIP message having a voice capable session description and a SIP message having an on-hold session description.

### BACKGROUND

1. Field of the Present Invention

The invention is in the field of telecommunications and, more particularly, telephone systems in which hold queues are employed.

2. History of Related Art

In conventional telephone networks, call hold queuing systems are implemented in a one-side or unidirectional manner. Specifically, hold queues are typically used only by the party that receives the call. When a customer calls a service provider, the customer must frequently endure an extended and annoying wait in a call hold queue if the caller wishes to speak with a representative of the service provider. During this time, the customer's utilization of his or her time is usually poor because the customer is required to continuously monitor the status of the call. For example, the customer is unable to initiate a second call without jeopardizing the status of the first call. In contrast, the party receiving the call (e.g., the service provider) experiences peak or close-to-peak utilization because the receiving party is almost always on the line with somebody and has no substantial idle time. Most consumers have experienced the frustration of waiting on hold for extended periods of time. It would be desirable to implement a communication system in which hold queues were implemented more symmetrically, giving both parties to a call the opportunity to improve their respective utilizations through the use of hold queues.

### SUMMARY OF THE INVENTION

The objective identified above is achieved with a communication system and method that include a first user agent initiating a telephone call to a second user agent. An intermediary agent establishes a first connection to the first user agent and a second connection to the second user agent. If the intermediary determines that the second user agent has placed the first user agent on hold, the intermediary terminates the first connection while maintaining the second connection on behalf of the first user agent. When the second user agent becomes available, it informs the intermediary. The intermediary then determines the availability of the first user agent. If the first user agent is available, it is connected to the second user agent. The agents preferably communicate over an IP network using session initiation protocol (SIP) compliant messages. The agents and the intermediary are configured to differentiate between a SIP message having a voice capable session description and a SIP message having an on-hold session description.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a communication system suitable for implementing the present invention;

FIG. 2 is a flow diagram depicting instructions in a computer program produce for implementing two-way on-hold functionality in the communication system of FIG. 1;

FIG. 3 is a conceptual diagram of messages exchanged among the components of FIG. 1 during selected stages of the instructions illustrated in FIG. 2;

FIG. 4 is a conceptual diagram of messages exchanged among the components of FIG. 1 during selected stages of the instructions illustrated in FIG. 2;

FIG. 5 is a conceptual diagram of messages exchanged among the components of FIG. 1 during selected stages of the instructions illustrated in FIG. 2; and

FIG. 6 is a conceptual diagram of messages exchanged among the components of FIG. 1 during selected stages of the instructions illustrated in FIG. 2.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the invention encompasses a communication system and method for enabling both parties (referred to herein as agents) to a telephone connection to place the call on hold. The preferred implementation uses an intermediary to facilitate this extended functionality. The first user agent initiates a first call to the second user agent using the intermediary to make the connection. In this configuration, the first and second user agents communicates directly to the intermediary. If the second user agent places the first user agent on hold, the intermediary may terminate its connection with the first user agent while maintaining the connection to the second user agent in lieu of or on behalf of the first user agent. In this manner, the intermediary maintains the first user agent's priority in the second user agent's hold queue while simultaneously enabling the first user agent to initiate another call. When the second user agent is ready to speak with the first, the second user agent informs the intermediary. The intermediary then queries the first user agent to see if the first user agent is available to establish a connection with the second user agent. If the first user agent is available, the connection is established. If, however, the first user agent is on a call to a third agent, the intermediary discovers this fact and reports it to the second user agent. The second user agent then bypasses the first user agent in the hold queue and selects the highest priority request having an available status. The first user agent is not deleted from the second user agent's hold queue, but is merely pushed back onto the queue. In this manner, the first and second user agents both experience high utilization because neither is forced to endure long idle hold periods. Instead, the first user agent is free to initiate calls to other agents while remaining on hold with the second user agent and the second user agent is free to take calls from the highest priority caller that is available.

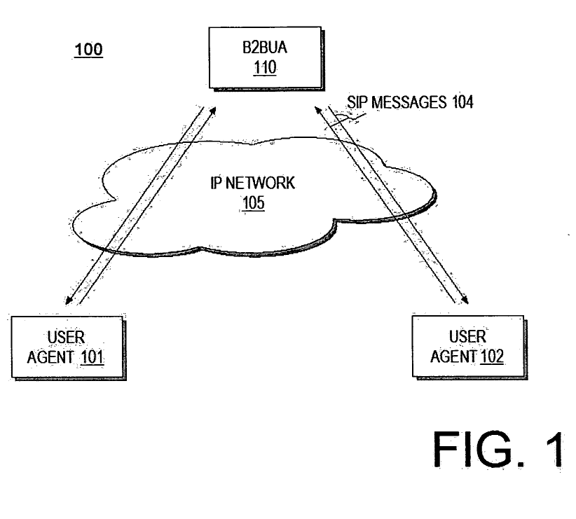

Referring now to the drawings, FIG. 1 is a block diagram of selected elements of a communication system suitable for implementing two-way on-hold functionality according an embodiment of the present invention. In an implementation applicable to a rapidly evolving technology, telecommunication system 100 uses IP-based telephony. IP telephony refers to a class of devices, applications, and services that enable the transport of telephone calls over the Internet. IP telephony implementations vary in the types of devices used at either end of a telephone call (e.g., multimedia PCs, traditional telephones, dedicated terminals, etc.), but all IP telephony applications use the Internet for at least a portion of the connection between caller and callee.

The depicted embodiment of communication system 100 depicts the simple case of a single caller and a single callee. The caller is referred to as first user agent 101 and the callee is referred to as second user agent 102. User agents 101 and 102 include the hardware, firmware, and software required to participate in IP telephony. In a particularly popular implementation of IP telephony, communications system 100 including user agents 101 and 102 support the session description protocol (SDP) and the session initiation protocol (SIP).

SDP is a protocol for conveying information about media streams in multimedia sessions to allow the recipients of a session description to participate in the session. SDP provides a means to communicate the existence of a session and a means to convey sufficient information to enable others to join and participate in the session. A multimedia session is a set of multimedia senders and receivers and the data streams that flow between or among them. SDP is documented in the Internet Engineering Task Force RFC 2327, which is incorporated by reference herein in its entirety.

Session Initiation Protocol (SIP) is an application-layer control or signaling protocol for creating, modifying, and terminating sessions with one or more participants. SIP sessions include, in addition to Internet telephone calls, multimedia distribution and multimedia conferences. SIP invitations are used to create sessions and carry SDP compliant session descriptions that allow participants to agree on a set of compatible media types. SIP makes use of proxy servers to help route requests to the user's current location, authenticate and authorize users for services, implement provider call-routing policies, and provide features to users. SIP runs on top of several different transport protocols including UDP and TCP. SIP is documented in IETF RFC 3261, which is incorporated by reference in its' entirety herein.

In the depicted implementation of communication system 100, an intermediary agent, identified as back-to-back user agent (B2BUA) 110 is shown. B2BUA 110 is a logical entity that receives requests as a SIP User Agent Server (UAS) and responds to requests acting as a SIP User Agent Client (UAC). B2BUA 110 also maintains dialog state and participates in all of the requests sent on the connections or dialogs it has established. Because B2BUA is a concatenation of a SIP UAC and a SIP UAS, which are both well defined in the SIP standard, the SIP standard does not provide an additional definition for this entity.

Returning to FIG. 1, B2BUA 110 receives requests from first user agent 101 and sends SIP responses to first user agent 101. B2BUA 110 also receives requests from second user agent 102 and sends SIP responses to second user agent 102. The requests and responses are sometimes collectively referred to herein as SIP messages or, more simply, messages which are identified by reference numeral 104. FIG. 1 depicts the connections between user agents 101 and 102, and B2BUA 110, as traversing a network and, more specifically, an IP network 105. User agents 101 and 102 are virtual entities in the sense that they are not necessarily bound to any particular hardware devices. First and second user agents may be mobile agents that change location frequently. In such embodiments, a proxy server (not shown) may be employed to provide a mapping between a user agent and a geographical address or location. Although FIG. 1 depicts a case of a connection between just two user agents, those skilled in the field will readily recognize that the invention is capable of expansion to multicast environments.

In some embodiments, portions of B2BUA 110, first user agent 101, and second user agent 102 are implemented as computer program products that include a set or sequence of computer executable instructions (software) for implementing 2-way, on-hold functionality in an IP based telephony environment. In these embodiments, the instructions are stored on or embedded in a computer readable storage medium such as a hard disk, a flash memory device, a CD, a DVD, a magnetic tape, and the like.

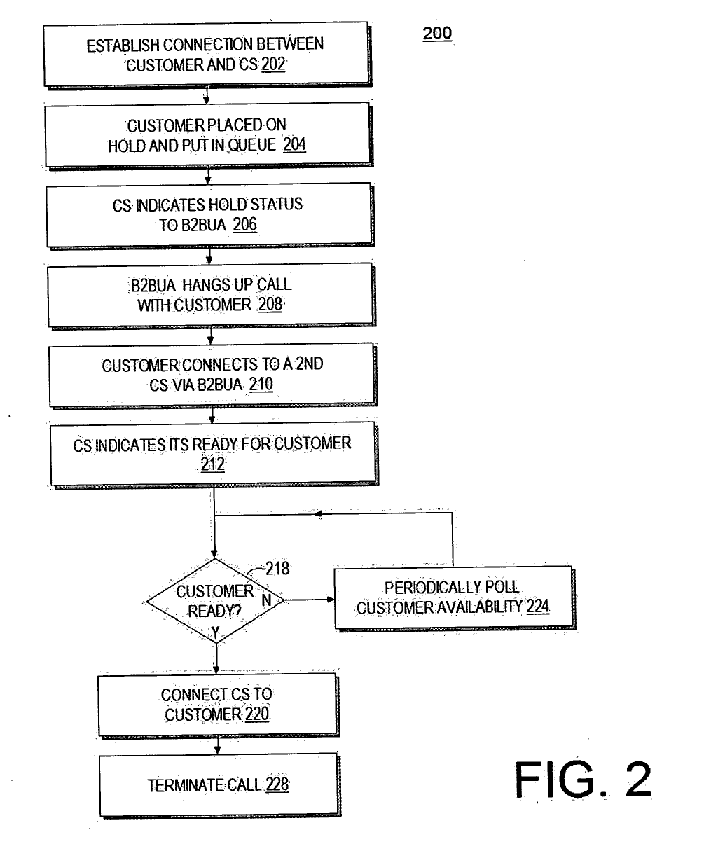

Referring now to FIG. 2, a flow diagram illustrates a method 200 of providing 2-way, on-hold functionality according to one embodiment of the present invention. The depicted flow diagram refers to a customer and two or more customer service (CS) entities. The customer corresponds to the first user agent 101 depicted in FIG. 1 while the first CS entity corresponds to the second user agent 102. Referring to first user agent 101 of FIG. 1 as a customer and to second user agent 102 as a customer service entity emphasizes an application or setting in which the present invention is likely to have a significant beneficial impact. Specifically, the 2-way, on-hold functionality enables a customer to decrease the amount of idle time spend on-hold when the customer attempts to contact a service provider by telephone. Consumers will readily appreciate the frustration and opportunity cost associated with the long wait periods that consumers have come to expect from automated voice answering systems, call centers, and the like. The present invention addresses these issues with a method and system that enable consumers to improve their productivity when they are placed in a long hold queue upon after calling a service provider. In a convention telephone implementation, whether it is an public switched telephone network (PSTN) or an IP-based network, consumers who are placed on hold must either remain on-hold for an extended and largely undetermined amount of time or hang up and try again later. Neither of these alternatives is attractive. The present invention provides a third alternative, namely, to remain on hold with the first customer service call while initiating a second call, perhaps to a second customer service center.

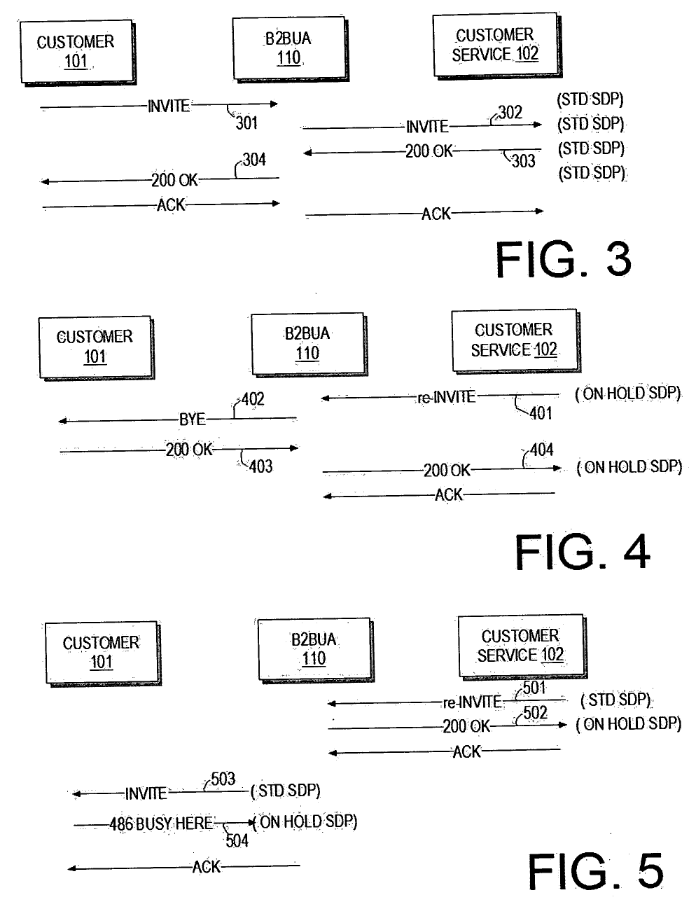

Referring again to FIG. 2, method 200 includes establishing (block 202) a voice-capable connection between first user agent (customer) 101 and second user agent (customer service or CS) 102. In an embodiment employing IP-based telephony, block 202 includes initiating a SIP/SDP compliant session between customer 101 and customer service 102. Details of one such implementation are depicted in FIG. 3, in which customer 101 sends a SIP INVITE request (301) that is received by B2BUA 110 acting as an intermediary between customer 101 and customer service 102. B2BUA 110 determines the intended destination for the request from INVITE 301 and sends INVITE 302 to customer service 102. INVITE 302 is likely to be substantively and functionally equivalent to INVITE 301. For example, INVITE 301 and INVITE 302 will indicate customer 101 as the initiator of the session. In the depicted example, customer service 102 responds to INVITE 302 by returning a SIP compliant 200 OK response (303) indicating that customer service has received and accepted the INVITE. The OK response 303 is handled by B2BUA 110, which sends a corresponding 200 OK response (304) to customer 101. Customer 101 acknowledges the OK response to B2BUA 110 and B2BUA 110 then acknowledges the OK response from customer service 102. The SIP requests and responses 301 through 304 of FIG. 3, contain “standard” voice capable session description content. At this point, a session is established between customer 101 and customer service 102. More specifically, a connection is established between customer 101 and B2BUA 110 and a corresponding connection is established between B2BUA 110 and customer service 102 where B2BUA 110 acts as an intermediary for voice content.

Returning to FIG. 2, the depicted embodiment of method 200 includes customer 101 being placed (block 204) on hold and put in a hold queue by customer service 102. Customer service then informs (block 206) B2BUA 110 that customer 101 is on hold. Customer service 102 may place customer 101 on hold directly or after a series of responses in an automated call handling system or voicemail system. Referring to FIG. 4, the SIP messages (requests and responses) that correspond to block 204 of FIG. 2 include customer service 102 sending a re-INVITE request 401 to B2BUA 110. Re-INVITE request 401 includes an SDP compliant session description that indicates that customer 101 is now on hold. The session description may be a particular “on hold” session description or, in another embodiment, the session description may include be a “black hole” session description indicating that no voice data will be transmitted by customer service 102. Regardless of the implementation of re-INVITE 401, B2BUA 110 and customer service 102 are able to distinguish between a standard session description and an “on hold” session description.

B2BUA 110 is a state machine that responds to re-INVITE 401 or, more specifically, to the “on hold” session description contained in re-INVITE 401, by terminating or hanging up (FIG. 2, block 208) the corresponding connection between B2BUA 110 and customer 101. This step is indicated in FIG. 4 as the BYE request 402 sent from B2BUA 110 to customer 101, the corresponding 200 OK responses 403 and 404, and the ACK. Prior to disconnecting with customer 101, B2BUA 110 may play a short message indicating that the customer has been placed on hold with customer service 102.

An important feature of system 200 of FIG. 2 and B2BUA agent 110 is that B2BUA 110 maintains on behalf of customer 101 the connection between customer service 102 and B2BUA 110 while the connection between customer 101 and B2BUA 110 is terminated. Disconnecting the connection between customer 101 and B2BUA 110 frees customer 101 to initiate another session (e.g., to a second customer service call center) as is shown in FIG. 2, block 210, while maintaining the session between B2BUA 110 and customer 101 keeps the customer's place in the hold queue of customer 101. Thus, for all SIP signaling purposes, B2BUA 110 remains waiting for customer service 102 as part of the original call even though the initiator of the initial call has established a new and different session.

After some time has passed, the customer's priority in the hold queue of customer service 110 “bubbles” to the top meaning that customer service 102 is ready to service customer 101. Customer service indicates (FIG. 2, block 212) that it is ready for customer 101 and determines (block 218) whether customer 101 is ready to communicate with customer service 102. Referring to an implementation depicted in FIG. 5, customer service 102 indicates it is ready to communicate with customer 101 by sending a re-re-INVITE request 501 to B2BUA 110. Unlike re-INVITE 401 of FIG. 4, re-INVITE request 501 has a standard session description. B2BUA 110 responds to the re-INVITE by sending 200 OK response 502, which has an on-hold session description reflecting the current state of the connection between customer 101 and customer service 102. B2BUA 110 acknowledges response 502.

B2BUA 110 determines whether customer 101 is ready to communicate with customer service 102 by sending a standard SDP INVITE request 503 to customer 101. In the depicted instance, customer 101 has initiated and established a connection with another party, perhaps a second service provider, when INVITE request 503 arrives and customer 101 responds to INVITE request 503 with a SIP 486 BUSY HERE response (504). Because customer 101 is not available for communicating with customer service 102, no change in status of the call is required at this point. Customer 101 may, however, implement a call waiting feature that informs the user of the re-INVITE request 501 and permits customer 101 the opportunity to accept the invitation before sending the busy here response 504.

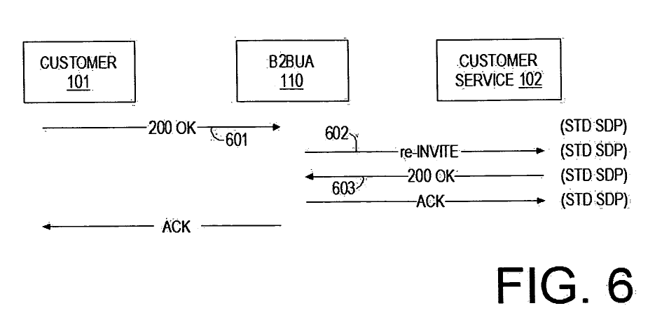

B2BUA 110 then polls (FIG. 2, block 224) customer 101 from time to time with subsequent instances of INVITE request 503. Eventually, customer 101 will respond to INVITE request 503 with a 200 OK response such as the 200 OK response (601) depicted in FIG. 6. When B2BUA 110 receives response 601 indicating that customer 101 is available, B2BUA 110 sends a re-INVITE 602 having a STD SDP. Customer service 102 responds with a 200 OK response 603 having a standard session description indicating that customer service 102 has updated its indicated status for customer 101 from unavailable to available. At this point, customer 101 is available, customer service 102 is aware of the customer's availability, and, presumably, customer 101 has a high priority in the hold queue of customer service 102. Under these conditions, the hold time for customer 101 is likely to be relatively short and bearable. When customer service 102 is ready to take its next call and customer 101 is the highest priority caller with an available status, the connection between customer 101 and customer service 102 is completed (block 220). After the parties complete their call, the call is then terminated (block 228) according to conventional SIP policies.

It will be apparent to those skilled in the art having the benefit of this disclosure that the present invention contemplates a communication system and method for providing two-way hold queues. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method for managing telephone calls in a communication system, comprising:
initiating a telephone call from a first user agent to a second user agent;
responsive to said initiating, establishing by an intermediary agent, a first connection between the first user agent and the intermediary agent and a second connection between the second user agent and the intermediary agent;
responsive to the intermediary agent determining that the second user agent has placed the first user agent on hold, terminating the first connection while maintaining the second connection on behalf of the first user agent;
responsive to the second user agent becoming available to communicate with the first user agent, informing, by the second user agent, the intermediary agent that the second user agent is available and determining, by the intermediary agent, availability of the first user agent; and
responsive to the first user agent being available, connecting the first user agent to the second user agent.

2. The method of claim 1, wherein the first user agent, the intermediary agent, and the second user agent communicate over an IP network.

3. The method of claim 2, wherein the first and second user agents communicate with the intermediary agent using session initiation protocol (SIP) compliant messages.

4. The method of claim 3, wherein the first user agent, the second user agent, and the intermediary agent are configured to differentiate between a SIP message having a voice capable session description and a SIP message having an on-hold session description and further wherein determining that the second user agent has placed the first user agent on hold includes sending, by the second user agent, a message with an SDP compliant session description indicating that the first user agent has been placed on hold.

5. The method of claim 4, wherein initiating the telephone call includes the first user agent sending an INVITE request to the intermediary, the intermediary sending an INVITE request to the second user agent, the second user agent sending an OK response with a voice capable session description to the intermediary and the intermediary sending an OK response to the first user agent and further comprising placing the first user agent on hold by sending a re-INVITE request with an on-hold session description to the intermediary.

6. The method of claim 1, further comprising, responsive to the intermediary terminating the first connection, initiating, by the first user agent, a second call to another user agent.

7. The method of claim 1, responsive to the intermediary agent determining that the first user agent is unavailable, polling the first user agent for its availability status.

8. A computer program product comprising computer executable instructions, stored on a computer readable medium, for managing telephone calls, the instructions comprising:
instructions for establishing an IP-based telephony first connection between an intermediary and a first user agent and a second connection between the intermediary and a second user agent responsive to the first user agent initiating a call to the second user agent; and
responsive to the second user agent placing the first user agent on hold, instructions for enabling the first user agent to initiate a second call to another agent while maintaining the connection between the intermediary and the second user agent on behalf of the first user agent, wherein the first user agent remains on hold with the second user agent.

9. The computer program product of claim 8, wherein the instructions for establishing comprise instructions for communicating using session initiation protocol (SIP) compliant messages.

10. The computer program product of claim 9, further comprising instructions for differentiating between a SIP message having a voice capable session description and a SIP message having an on-hold session description.

11. The computer program product of claim 10, the instructions for establishing comprise first user agent instructions for sending an INVITE request to the intermediary, intermediary instructions for sending the INVITE request to the second user agent, second user agent instructions for sending an OK response with an voice capable session description to the intermediary and intermediary instructions for sending an OK response to the first user agent and further comprising intermediary instructions for placing the first user agent on hold by sending a re-INVITE request with an on-hold session description to the second user agent.

12. The computer program product of claim 8, further comprising, responsive to the intermediary terminating the first connection, instructions for initiating, by the first user agent, a second call to another user agent.

13. The computer program product of claim 8, further comprising instructions for periodically polling the first user agent for its availability status responsive to the intermediary agent determining that the first user agent is unavailable.

14. An IP-telephony communication system, comprising
a first user agent configured to initiate a first call to a second user agent; and
an intermediary configured to detect the initiation of the first call and to respond by establishing a first connection with the first user agent and a second connection with the second user agent;
wherein the intermediary is further configured to respond to detecting that the second user agent has placed the first user agent on hold, by terminating the first connection while maintaining the second connection on behalf of the first user agent; and
wherein the first user agent is configured to respond to termination of the first connection by permitting a user to initiate a second call to a third agent while the intermediary maintains the second connection.

15. The system of claim 14, wherein the second user agent is configured to prompt the intermediary, via the second connection, to establish a connection to the first user agent responsive to the second user agent taking the first user agent off hold.

16. The system of claim 15, wherein the intermediary is configured to respond to the prompt by inviting the first user agent to connect to establish a connection.

17. The system of claim 16, wherein the first user agent is configured to respond to the invitation with a busy indicator if the first user agent has established a connection with a third agent and to accept the invitation if the first user agent is not connected to another agent.

18. The system of claim 17, wherein the first user agent is further configured to inform the user of the invitation and allow the user to accept the invitation prior to responding to the invitation with the busy indicator.

19. The system of claim 14, wherein the intermediary established connections with the first and second user agents using SIP compliant messages.

20. The system of claim 19, wherein the first user agent, the second user agent, and the intermediary are configured to differentiate between a SIP message having a voice capable session description and a SIP message having an on-hold session description and further wherein detecting that the second user agent has placed the first user agent on hold includes sending, by the second user agent, a message with an SDP compliant session description indicating that the first user agent has been placed on hold.
